(19) United States
(12) Patent Application Publication
(10) Pub. No.: US 2005/0015328 A1
(43) Pub. Date: Jan. 20, 2005

(54) Method and system to allocate resources in a general exchange environment

(76) Inventors: Yang Zhu, Gainesville, FL (US); Zuo-Jun Shen, Gainesville, FL (US)

Correspondence Address: Yang Zhu, Apt. 8, 284 Corry Village, Gainesville, FL, 32603, US

(21) Appl. No.: 10/890,307

(22) Filed: Jul. 13, 2004

Related U.S. Application Data
(60) Provisional application No. 60/487,556, filed on Jul. 15, 2003.

(51) Int. Cl. G06F 17/60

(52) U.S. Cl. 705/37

(57) ABSTRACT

A method for conducting a double auction can include computing a double entering price for each buyer, comparing the double entering price of each buyer with a bid for the buyer, and excluding buyers having a double entering price that exceeds the buyer's bid from the double auction. The remaining buyers can be paired with sellers, and the transaction prices can be determined. By interchanging the roles of buyers and sellers in the procedure, the corresponding seller side method can be obtained.

### BACKGROUND

1. Field of the Invention

This invention relates to the field of auctions.

2. Description of the Related Art

Online auctions conducted over the Internet have allowed buyers and sellers located in geographically disparate locations to exchange goods and services more easily. While online auctions have been embraced with respect to individuals, the efficiency with which such systems operate also has peaked the interest of the business community. In consequence, online auctions systems have gained favor with businesses in the area of procurement.

Many conventional auction systems utilize one-sided auction system. In a one-sided auction, only bids or asks are permitted, but not both. In contrast, double auctions allow buyers to place bids and also allow sellers to place asks at the same time.

Impossibility results have shown that it is not possible to concurrently achieve efficiency, budget balance, individual-rationality, and incentive compatibility when implementing double auctions. For example, some double auction systems are strategy-proof and efficient, but do not satisfy the budget-balanced condition. Other double auction systems are ex-ante budget balanced and individual rational, but achieve budget balance through charging entrance fees.

Other double auction systems provide environments in which neither the auctioneer nor the agents have knowledge about valuations. Such systems are incentive compatible, individual rational, weakly budget-balanced, but are based upon rankings. Generally, sellers' asks are ranked and buyers' bids are ranked to better match buyers and sellers. Use of ranking within auction systems, however, does not lend itself to uses in more general settings and/or environments.

Still, conventional double auction systems which are incentive compatible cannot handle or process pair-related costs, such as transportation costs and/or handling costs.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating:an exemplary system for conducting online or network-based auctions with a plurality of buyers and sellers.

FIG. 2 is a flow chart illustrating an exemplary buyer side method for determining which buyers and sellers will win an auction and their transaction prices.

FIG. 3 is a flow chart illustrating an exemplary seller side method for determining which buyers and sellers will win an auction and their transaction prices.

### DETAILED DESCRIPTION OF THE INVENTION

The present invention provides a solution for pair-related costs in double auction environments. According to one embodiment of the present invention, an auction system is provided that is strategy-proof, individual rational, weakly budget-balanced, and asymptotically efficient under some circumstances. The present invention can improve total system welfare as well as the payoff for participating bidders in comparison to conventional one-sided auction systems.

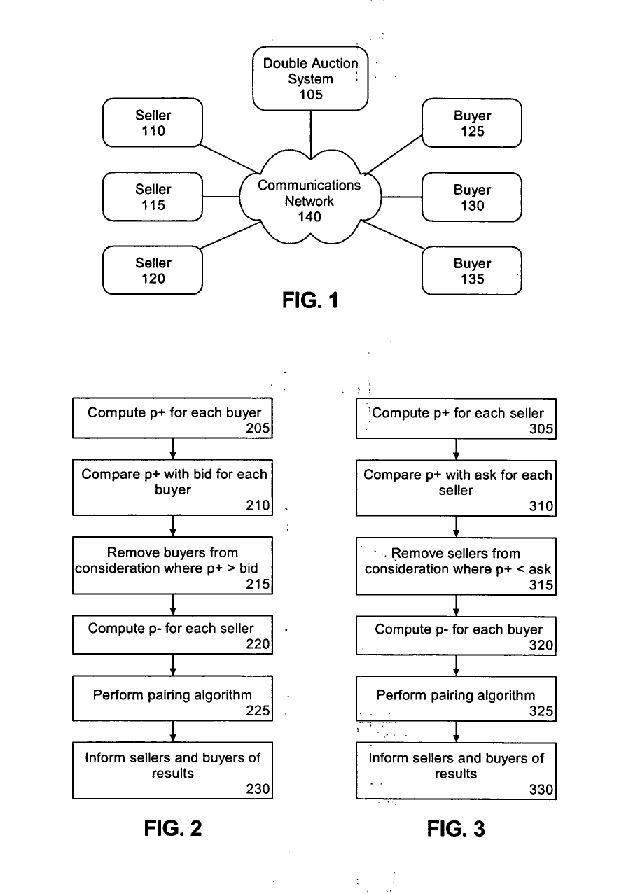

FIG. 1 is a schematic diagram illustrating an exemplary system for conducting online or network-based auctions with a plurality of buyers and sellers. As shown, the system can include a double auction system (DAS) 105, a plurality of sellers 110, 115, and 120, and a plurality of buyers 125, 130, and 135. Each of the sellers 110-120 and buyers 125-135 can be communicatively linked with one another as well as the DAS 105 via the communications network 140.

Each of the sellers 110-120 and buyers 125-135 shown, also can be computer systems through which individual and/or entities such as business can interact. For example, the buyer and seller computer systems can include, but are not limited to, servers, general purpose computer systems, or portable computer systems such as laptop computers, cellular telephones, personal digital assistants, and the like.

As noted, each seller 110-120 and buyer 125-135 can be interconnected with one another and the DAS 105 via a suitable communications network 105. The communications network 105 can be the Internet, the Web, a Local Area Network (LAN), a Wide Area Network (WAN), the Public Switched Telephone Network (PSTN), or any other suitable communications network capable of supporting communications among the sellers 110-120, the buyers 125-135, and the DAS 105.

The DAS 105 can be implemented as a computer system having a suitable network connection. The DAS 105 can be implemented as a centralized computer system such as a server, a general purpose computer system, or processor within a larger computer system, having appropriate software for performing the various functions disclosed herein.

The DAS 105 can be configured to support an Agent Competition Double Auction (AC-DA). The AC-DA implemented by the DAS 105, under certain welfare functions such as the quasi-linear function, can be strategy-proof, individual rational, weakly budget-balanced, and asymptotically efficient for a simple exchange environment with pair related costs. Generally, a welfare function that is quasi-linear refers to the difference between a buyer's and a seller's (collectively “agent”) valuation of the item being bought and/or sold; and the amount of money the agent receives and/or pays.

The DAS 105 can support a-simple exchange environment where each buyer wants to purchase one unit of an indivisible homogeneous item and each seller has one unit of the item to sell as well as the same environment including pair related costs, such as transportation costs, shipping costs, handling costs, and the like. Further the DAS 105 can support a multi-unit exchange enviroment where each seller can submit an ask with multiple units and has multiple units to sell and each buyer wants to purchase one unit of an indivisible homogehous item. In a multi-unit exchange environment, the ask submitted by each seller can be the per unit price of that seller's bundle of goods.

Within the context of an AC-DA, the DAS 105 allows multiple buyers and sellers to participate concurrently. Rather than conducting a series of individual seller run actions, similar or identical goods grouped and offered at auction from a plurality of sellers. Thus, if a buyer wishes to purchase good X; the buyer can place a bid for good X that can be compared with a pool of such goods offered from one or more sellers. The DAS 105 performs matching between buyers and sellers and determines which buyers and sellers win at which prices, that is which sellers sell goods and which buyers buy goods and how much money each agent receives and/or pays.

FIG. 2 is a flow chart illustrating an exemplary buyer side method for determining which buyers and sellers will win an auction and their transaction prices. The method can begin in a state where one or more seller, each offers a same or similar item for sale, and submits an ask, and where one or more buyer submits a bid on the items.

In step 205, a p+ value can be computed for each buyer in the auction. The p+ value refers to the double entering price, which is the infimum (supremum) of bid prices for an agent A to make the maximum system welfare according to the bid price lesser than the maximum system welfare with one more fictitious agent, who is identical to the agent A, while keeping the bids of other agents the same. The p+ value of a buyer B can be calculated by the following steps: i) assume buyer B bids some very high price P; ii) calculate the difference of the maximum system welfare with one more agent identical to the buyer B and the maximum system welfare; iii) minus the difference from P, the result is p+ of buyer B.

In step 210, the values of p+ calculated for each buyer can be compared. In step 215, any buyers having a calculated value of p+ that is greater than the buyer's own bid can be removed from consideration and participation in the auction.

In step 220, a p− value can be computed for each seller in the remaining system. The p− value refers to the entering price, which is the infimum (supremum) of bid prices for an agent to make the maximum system welfare according to the bid price greater than the maximum system welfare without the agent, while keeping the bids of other agents the same. The p− value of a seller S can be calculated by the following steps: i) assume seller S bids some very low price P; ii) calculate the difference of the maximum system welfare and the maximum system welfare without seller S; iii) add the difference to P, the result is p− of seller S.

In step 225, the remaining buyers can be paired up with sellers to determine the allocation of the resources, that is which buyers and sellers will win. The allocation is the allocation that maximizes the system welfare of the remaining system, which consists of remaining buyers and all the sellers. The amount of money each winning seller receives is the p− of the seller in the remaining system. The amount of money each winning buyer pays is the p+ of the buyer in the original auction system. Still, the pairing algorithm can take into account various pair-related costs such as shipping, transportation, handling, and the like.

For example, the DAS can be programmed with a variety of buyer and seller profiles including shipping addresses such that distances can be calculated for potential buyer-seller pairs to determine shipping costs. Further, each seller can have a profile specifying various costs for items being sold. Such a profile can specify a flat price for shipping particular items or a price per unit of distance to be shipped. Such parameters also can be based upon the weight of an item, the item type, whether the item is fragile, the overall size of the item, and the packing materials required to safely ship the item. Those skilled in the art will appreciate that pair-related costs can be specified in any of a variety of different ways and that the present invention should not be limited to the particular techniques used to specify pair-related costs.

In step 230, the winning buyers and sellers can be notified. As not each seller and/or buyer may win a particular auction, the winning agents can be notified via a suitable notification mechanism, whether conventional mail, electronic mail, telephone call, text message, instant message, facsimile, simply logging into an online auction account, or the like.

FIG. 3 is a flow chart illustrating an exemplary seller side method for determining which buyers and sellers will win an auction and their transaction prices. The method can begin as described with reference to FIG. 2. In step 305, a p+ value can be computed for each seller in the auction. In step 310, the values of p+ calculated for each seller can be compared. In step 315, any sellers having a calculated value of p+ that is lesser than the seller's own ask can be removed from consideration and participation in the auction. In step 320, the p− values of the buyers in the remaining system can be calculated.

In step 325, the remaining sellers can be paired up with buyers using a pairing technique as described with refernce to FIG. 2. The p− values of the buyers in the remaining system are the transaction prices for winning buyers, while the p+ values of the seller in original auction system are the transaction prices for winning sellers. In step 330, the winning buyers and sellers can be notified. As not each seller and/or buyer may win a particular auction, the winning agents can be notified via a suitable notification mechanism as previously described.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries but the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

Each of the references cited herein is fully 5incorporated by reference.

This invention can be embodied in other forms without departing from the spirit or essential attributes thereof. Accordingly, reference should be made to the following claims, rather than to the foregoing specification, as indicating the scope of the invention.

1. A method for conducting a double auction comprising:
computing a double entering price for each buyer;
comparing the double entering price of each buyer with a bid for the buyer;
excluding buyers having a double entering price that exceed the buyer's bid from the double auction;
computing an entering price for each seller; and
pairing the remaining buyers with sellers.

2. The method of claim 1, further comprising notifying paired buyers and sellers.

3. A method for conducting a double auction comprising:
computing a double entering price for each seller;
comparing the double entering price of each seller with an ask for the seller;
excluding sellers having a double entering price that does not exceed the seller's ask from the double auction;
computing an entering price for each buyer; and
pairing the remaining sellers with buyers.

4. The method of claim 3, further comprising notifying paired buyers and sellers.
